(19) United States
(12) Patent Application Publication
(10) Pub. No.: US 2019/0316822 A1
(43) Pub. Date: Oct. 17, 2019

(54) REFRIGERATION CYCLE APPARATUS

(71) Applicant: DENSO CORPORATION, Kariya-city (JP)

(72) Inventors: Kazuhiro TADA, Kariya-city (JP); Kenichi MARUYAMA, Kariya-city (JP); Fujio NOMURA, Kariya-city (JP)

(21) Appl. No.: 16/427,672

(22) Filed: May 31, 2019

Related U.S. Application Data
(63) Continuation of application No. PCT/JP2017/039649, filed on Nov. 2, 2017.

(30) Foreign Application Priority Data
Dec. 16, 2016 (JP) 2016-244155

(51) Int. Cl. F25B 49/02; B60H 1/32; B60H 1/00

(52) U.S. Cl. CPC F25B 49/022; B60H 2001/3272; B60H 1/00428; B60H 1/32

(57) ABSTRACT

A refrigeration cycle apparatus includes: an electric compressor that compresses and discharges refrigerant; a heating heat exchanger that heats a fluid by high pressure refrigerant discharged from the electric compressor as a heat source; a decompressor that decompresses the refrigerant flowing from the heating heat exchanger; an evaporator that evaporates the refrigerant decompressed by the decompressor; and a rotational speed controller that controls a rotational speed of the electric compressor. The rotational speed controller is configured to reduce an upper limit value of the rotational speed of the electric compressor in accordance with an increase in a pressure ratio of a high-pressure side refrigerant pressure of refrigerant within a range from a discharge port of the compressor to an inlet side of the decompressor to a low-pressure side refrigerant pressure of refrigerant within a range from an outlet side of the decompressor to a suction port of the compressor.

### CROSS REFERENCE TO RELATED APPLICATIONS

The present application is a continuation application of International Patent Application No. PCT/JP2017/039649 filed on Nov. 2, 2017, which designated the United States and claims the benefit of priority from Japanese Patent Application No. 2016-244155 filed on Dec. 16, 2016. The entire disclosures of all of the above applications are incorporated herein by reference.

### TECHNICAL FIELD

The present disclosure relates to a refrigeration cycle apparatus.

### BACKGROUND

A refrigeration cycle device is configured to lower the upper limit value of the rotational speed of the compressor as the pressure of the high pressure side refrigerant in the refrigeration cycle increases.

### SUMMARY

According to an aspect of the present disclosure, a refrigeration cycle apparatus includes:

an electric compressor that compresses and discharges refrigerant;

a heating heat exchanger that heats a fluid to be heated by high pressure refrigerant discharged from the electric compressor as a heat source;

a decompressor that decompresses the refrigerant flowing from the heating heat exchanger;

an evaporator that evaporates the refrigerant decompressed by the decompressor; and

a rotational speed controller that controls a rotational speed of the electric compressor.

The rotational speed controller is configured to reduce an upper limit value of the rotational speed of the electric compressor in accordance with an increase in a pressure ratio of a high-pressure side refrigerant pressure of refrigerant within a range from a discharge port of the compressor to an inlet side of the decompressor to a low-pressure side refrigerant pressure of refrigerant within a range from an outlet side of the decompressor to a suction port of the compressor.

### BRIEF DESCRIPTION OF THE DRAWINGS

FIG. 1 is a schematic view illustrating an air conditioner according to a first embodiment.

FIG. 2 is a block diagram illustrating a control system of the air conditioner of the first embodiment.

FIG. 3 is a flow chart of a control processing of the air conditioner of the first embodiment.

FIG. 4 is a flow chart of a subroutine to determine an operation mode in the control processing of the air conditioner of the first embodiment.

FIG. 5 is a diagram representing operating states of various air conditioning control devices in respective operation modes of the first embodiment.

FIG. 6 is a graph illustrating a relationship among a high-pressure side refrigerant pressure, a pressure ratio, a compressor rotational speed and a noise level.

FIG. 7 is a graph illustrating a relationship among a compressor rotational speed, an allowable noise level, and a pressure ratio.

FIG. 8 is a flow chart of a subroutine to determine an upper limit value of the rotational speed of the compressor according to the first embodiment.

FIG. 9 is a control characteristic diagram to determine the upper limit value of the rotational speed of the compressor according to the first embodiment.

FIG. 10 is an explanatory diagram illustrating transition of a pressure ratio, an upper limit value of the rotational speed, and a noise level while a frost is increasing in the first embodiment.

FIG. 11 is a flow chart of a subroutine to determine an upper limit value of the rotational speed of the compressor according to a second embodiment.

FIG. 12 is a control characteristic diagram to determine the upper limit value of the rotational speed of the compressor according to the second embodiment.

### DETAILED DESCRIPTION

To begin with, examples of relevant techniques will be described.

A refrigeration cycle device is configured to lower the upper limit value of the rotational speed of the compressor as the pressure of the high pressure side refrigerant in the refrigeration cycle increases. Since the pressure of the high pressure side refrigerant has a high correlation with the compression noise, the refrigeration cycle device controls the compressor as described above, to suppress the compression noise when the pressure of the high pressure side refrigerant is high.

In addition, the refrigeration cycle device is configured to lower the upper limit value of the rotational speed of the compressor as the vehicle speed decreases. The compression noise is difficult to be masked by the engine sound when the vehicle speed is low. Therefore, the refrigeration cycle device attempts to suppress the compression noise, which is difficult to be masked when the vehicle speed is low, by controlling the rotational speed of the compressor as the vehicle speed decreases.

In the refrigeration cycle device, the upper limit value of the rotational speed of the compressor is lowered simply based on the high-pressure side refrigerant pressure and the decrease in the vehicle speed. In other words, it cannot be said that the upper limit value is appropriately determined to reduce the noise.

For example, the noise reduction effect by determining the upper limit value of the rotational speed of the compressor may be excessive when a defrosting operation of a heat-absorbing heat exchanger is executed while the vehicle is stopped. In this case, since the operation of the compressor is restricted more than necessary, the noise reduction effect is excessive, during the defrosting operation. That is, in a conventional example, in order to obtain the noise reduction effect more than necessary, it takes long time to complete the defrosting operation while it is preferable to complete the defrosting operation in a shorter period of time. Therefore, it is desirable to more appropriately determine the upper limit value of the rotational speed of the compressor to obtain the noise reduction effect.

According to the study by the inventors, there are some cases where the operation sound of the compressor is not unpleasant even when the high-pressure side refrigerant pressure has reached a relatively high value. Thus, it is conceivable that the operation sound of the compressor is affected not only by the high-pressure side refrigerant pressure but also by other factors. In this regard, when only the high-pressure side refrigerant pressure is taken into consideration as a factor relating to the refrigeration cycle, it is impossible to obtain appropriate noise reduction effect.

The present disclosure provides a refrigeration cycle apparatus for an air conditioner for a vehicle, to appropriately reduce the noise.

According to an aspect of the present disclosure, a refrigeration cycle apparatus includes:

an electric compressor that compresses and discharges refrigerant;

a heating heat exchanger that heats a fluid to be heated by high pressure refrigerant discharged from the electric compressor as a heat source;

a decompressor that decompresses the refrigerant flowing from the heating heat exchanger;

an evaporator that evaporates the refrigerant decompressed by the decompressor; and

a rotational speed controller that controls a rotational speed of the electric compressor.

The rotational speed controller is configured to reduce an upper limit value of the rotational speed of the electric compressor in accordance with an increase in a pressure ratio of a high-pressure side refrigerant pressure of refrigerant within a range from a discharge port of the compressor to an inlet side of the decompressor to a low-pressure side refrigerant pressure of refrigerant within a range from an outlet side of the decompressor to a suction port of the compressor.

According to the refrigeration cycle apparatus, it is possible to appropriately determine the operating condition of the refrigeration cycle apparatus due to the pressure ratio using the low pressure side refrigerant pressure in addition to the high pressure side refrigerant pressure in the cycle. Furthermore, in the refrigeration cycle apparatus, the upper limit value of the rotational speed in the electric compressor is lowered in accordance with an increase in the pressure ratio. Therefore, the noise caused by the operation of the electric compressor can be appropriately reduced in accordance with the operation state in the refrigeration cycle apparatus.

Embodiments will be described in detail with reference to the drawings. In the present disclosure, a refrigeration cycle apparatus is applied to an air conditioner 1 for a vehicle. In the respective embodiments, the same or equivalent parts are denoted by the same reference numerals in the drawings.

### First Embodiment

A refrigeration cycle apparatus 10 according to the first embodiment is applied to the air conditioner 1 mounted in a vehicle. The refrigeration cycle apparatus 10 performs the function of cooling or heating the blown air blown into the passenger compartment as the air conditioning target space for the air conditioner 1. Therefore, a fluid to be heated in the first embodiment is blown air.

In the refrigeration cycle apparatus 10, the refrigerant circuit is able to be switched among a heating mode, a cooling mode, and a defrosting mode. In the air conditioner 1, the heating mode is an operation mode in which air is heated and blown off to the vehicle interior. The cooling mode is an operation mode in which air is cooled and blown off to the vehicle interior. The defrosting mode is an operation mode selected for defrosting a heat exchanger (for example, outdoor heat exchanger 16) of the refrigeration cycle apparatus 10.

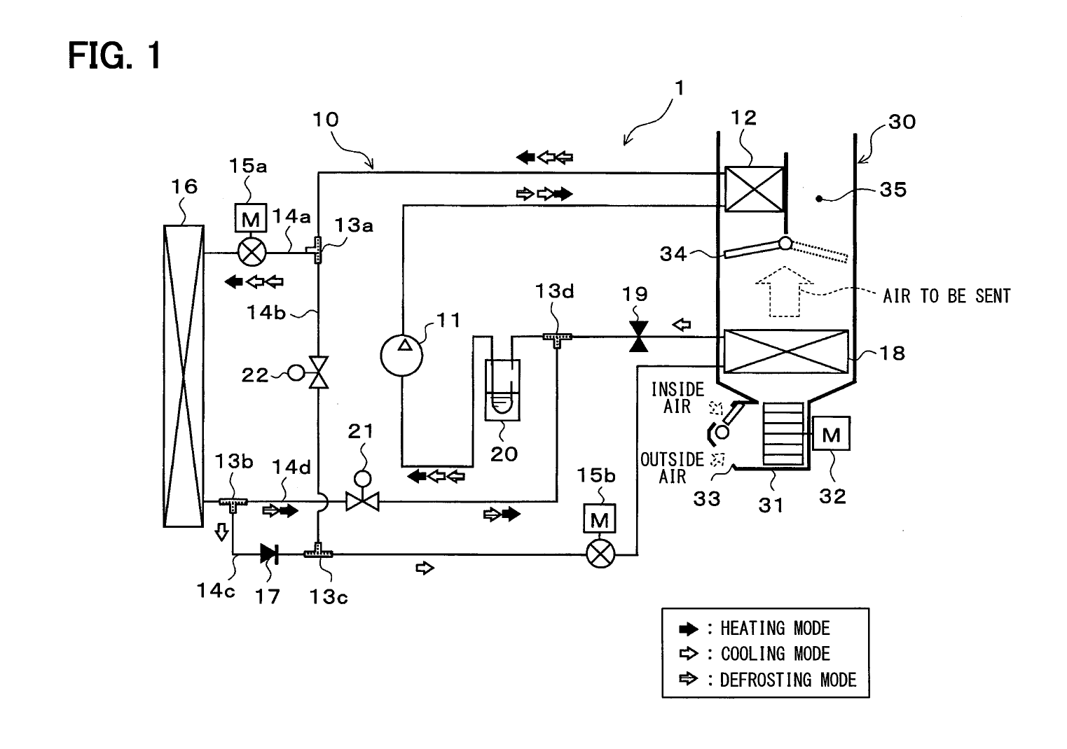

In FIG. 1, a black arrow represents a flow of refrigerant in the refrigerant circuit of the heating mode. A white arrow represents a flow of refrigerant in the refrigerant circuit of the cooling mode. A horizontal-hatching arrow represents a flow of refrigerant in the refrigerant circuit of the defrosting mode.

HFC base refrigerant (such as R134a) is adopted as a refrigerant in the refrigeration cycle apparatus 10, to form a vapor compression subcritical refrigeration cycle, where the high-pressure side refrigerant pressure Pc does not exceed the critical pressure of the refrigerant. As a refrigerant, HFO base refrigerant (for example, R1234yf), or natural refrigerant (for example, R744) may be adopted. Lubricating oil is mixed in the refrigerant to lubricate the compressor 11, and some of the oil circulates through the cycle with the refrigerant.

As shown in FIG. 1, the refrigeration cycle apparatus 10 has the compressor 11, the first expansion valve 15a, the second expansion valve 15b, the outdoor heat exchanger 16, the check valve 17, the indoor evaporator 18, the evaporating pressure regulating valve 19, the accumulator 20, the first opening-and-closing valve 21, and the second opening-and-closing valve 22.

The compressor 11 draws, compresses, and discharges the refrigerant in the refrigeration cycle apparatus 10. The compressor 11 is arranged in the bonnet of the vehicle. The compressor 11 is, for example, an electric compressor in which a fixed capacity type compressor mechanism is driven by an electric motor, while the discharge capacity is fixed. Various compressor mechanism such as scrolled type compressor mechanism and a vane type compressor mechanism are employable as the compressor mechanism.

The electric motor of the compressor 11 is controlled in the operation (such as number of rotations) by a control signal outputted from an air-conditioning control device 40. AC motor or DC motor is used as the electric motor. The refrigerant discharge of the compressor mechanism is changed by the air-conditioning control device 40 which controls the number of rotations of the electric motor. The electric motor corresponds to a discharge amount change part of the compressor mechanism.

A refrigerant inlet side of an indoor condenser 12 is connected to the discharge port of the compressor 11. The indoor condenser 12 functions as a heat exchanger for heating at the time of heating mode. That is, at the time of heating mode, the indoor condenser 12 heats air by heat exchange between the high temperature and high pressure refrigerant discharged from the compressor 11, and air which passes through the indoor evaporator 18. The indoor condenser 12 is arranged in a casing 31 of the indoor air-conditioning unit 30.

An inflow port of a first three-way joint 13a is connected to the refrigerant outlet of the indoor condenser 12. The first three-way joint 13a functions as a branch part or a unification part in the refrigeration cycle apparatus 10.

For example, among the three ports of the first three-way joint 13a, one is used as an inflow port for refrigerant discharged from the indoor condenser 12, and the other two are used as outlet ports for discharging to the first refrigerant passage 14a and the second refrigerant passage 14b. The first three-way joint 13a functions as a branch part where the flow of the refrigerant flowing in from one inflow port is branched to flow out from the two outlet ports. The three-way joint may be formed by joining plural pipes, or formed by providing plural refrigerant passages in a metal block or a resin block.

The refrigeration cycle apparatus 10 further has a second three-way joint 13b, a third three-way joint 13c, and a fourth three-way joint 13d. The fundamental configuration of the three-way joint 13b, 13c, 13d is the same as that of the first three-way joint 13a. For example, two ports are used as inflow ports, and the remaining one is used as an outlet port, in the fourth three-way joint 13d. The fourth three-way joint 13d functions as a unification part where the refrigerant flowing in from two inflow ports are joined and made to flow out of one outlet port.

The first refrigerant passage 14a is connected to one outlet port of the first three-way joint 13a. The first refrigerant passage 14a leads the refrigerant which flowed out of the indoor condenser 12 to the refrigerant inlet side of the outdoor heat exchanger 16.

The second refrigerant passage 14b is connected to the other outlet port of the first three-way joint 13a. The second refrigerant passage 14b leads the refrigerant which flowed out of the indoor condenser 12 to the inlet side of the second expansion valve 15b (specifically, to one port of the third three-way joint 13c) arranged in a third refrigerant passage 14c.

The first expansion valve 15a is arranged in the first refrigerant passage 14a. The first expansion valve 15a decompresses the refrigerant which flowed out of the indoor condenser 12 at the time of heating mode and defrosting mode. The first expansion valve 15a may correspond to a pressure reducing device. The first expansion valve 15a is a variable throttle mechanism having a valve object and an electric actuator. The opening degree of the valve object is changeable, and is controlled by a stepping motor of the electric actuator.

The first expansion valve 15a is a variable throttle mechanism with a full open function. Specifically, when the opening degree of the first expansion valve 15a is made full open, the first expansion valve 15a works as a mere refrigerant passage without a refrigerant decompression action. The operation of the first expansion valve 15a is controlled by a control signal (control pulse) outputted from the air-conditioning control device 40.

The refrigerant inlet side of the outdoor heat exchanger 16 is connected to the outlet side of the first expansion valve 15a, and the outdoor heat exchanger 16 is arranged at the front side in the vehicle bonnet. The outdoor heat exchanger 16 carries out heat exchange between the refrigerant which flowed out of the first expansion valve 15a, and outside air sent by a blower (not shown). The blower is an electric blower with which number of rotations (ventilation capability) is controlled by a control voltage outputted from the air-conditioning control device 40.

Specifically at the time of heating mode, the outdoor heat exchanger 16 functions as a heat absorber which absorbs heat from the outside air. At the time of cooling mode, the outdoor heat exchanger 16 functions as a radiator which radiates heat to the outside air.

One inflow port of the second three-way joint 13b is connected to the refrigerant outlet side of the outdoor heat exchanger 16. The third refrigerant passage 14c is connected to one outlet port of the second three-way joint 13b. The third refrigerant passage 14c leads the refrigerant which flowed out of the outdoor heat exchanger 16 to the refrigerant inlet side of the indoor evaporator 18.

The fourth refrigerant passage 14d is connected to the other outlet port of the second three-way joint 13b. The fourth refrigerant passage 14d leads the refrigerant which flowed out of the outdoor heat exchanger 16 to the inlet side of the accumulator 20 (specifically, one inflow port of the fourth three-way joint 13d).

The check valve 17, the third three-way joint 13c, and the second expansion valve 15b are arranged in this order in the refrigerant flow in the third refrigerant passage 14c. The check valve 17 permits refrigerant to flow only from the second three-way joint 13b to the indoor evaporator 18. The second refrigerant passage 14b is connected to the third three-way joint 13c.

The second expansion valve 15b decompresses the refrigerant which flows out of the outdoor heat exchanger 16 and flows into the indoor evaporator 18. The second expansion valve 15b corresponds to a pressure reducing device. The fundamental configuration of the second expansion valve 15b is the same as that of the first expansion valve 15a. The second expansion valve 15b is a variable throttle mechanism with full closing function. When the opening degree of the second expansion valve 15b is fully closed, this refrigerant passage is closed.

In the refrigeration cycle apparatus 10 of the first embodiment, the refrigerant circuit can be changed by fully closing the second expansion valve 15b to close the third refrigerant passage 14c. In other words, the second expansion valve 15b functions as a refrigerant pressure reducing device and a refrigerant circuit switch device which changes the refrigerant circuit in which the refrigerant circulates.

The indoor evaporator 18 functions as a heat exchanger for cooling at the time of cooling mode. That is, at the time of cooling mode, the indoor evaporator 18 carries out heat exchange between the refrigerant which flows out of the second expansion valve 15b, and air to flow into the indoor condenser 12. In the indoor evaporator 18, the refrigerant decompressed by the second expansion valve 15b is evaporated to cool the air by absorbing heat. The indoor evaporator 18 is arranged in the casing 31 of the indoor air-conditioning unit 30, at upstream of the indoor condenser 12 in the air flow.

The inflow port side of the evaporating pressure regulating valve 19 is connected to the refrigerant outlet of the indoor evaporator 18. The evaporating pressure regulating valve 19 adjusts the refrigerant evaporating pressure in the indoor evaporator 18 to be more than or equal to a frost restricting pressure, in order to restrict frost from being generated on the indoor evaporator 18. In other words, the evaporating pressure regulating valve 19 adjusts the refrigerant evaporation temperature in the indoor evaporator 18 to be more than or equal to a predetermined frost restricting temperature.

As shown in FIG. 1, the fourth three-way joint 13d is connected to the outlet side of the evaporating pressure regulating valve 19. The fourth refrigerant passage 14d is connected to the other inflow port of the fourth three-way joint 13d. The inlet side of the accumulator 20 is connected to the outlet of the fourth three-way joint 13d.

The accumulator 20 is a gas-liquid separator in which the refrigerant which flowed into is divided into gas and liquid, and stores the refrigerant surplus in the cycle. The inlet port side of the compressor 11 is connected to the gas refrigerant outlet of the accumulator 20. The accumulator 20 restricts liquid refrigerant from entering the compressor 11, and achieves the function to prevent the liquid compression in the compressor 11.

The first opening-and-closing valve 21 is arranged in the fourth refrigerant passage 14d which connects the second three-way joint 13b to the fourth three-way joint 13d. The first opening-and-closing valve 21 may be configured by an electromagnetic valve, and functions as a refrigerant circuit switching device which changes the refrigerant circuit by opening and closing the fourth refrigerant passage 14d. The operation of the first opening-and-closing valve 21 is controlled by a control signal outputted from the air-conditioning control device 40.

Similarly, the second opening-and-closing valve 22 is arranged in the second refrigerant passage 14b which connects the first three-way joint 13a to the third three-way joint 13c. The second opening-and-closing valve 22 may be configured by an electromagnetic valve, similarly to the first opening-and-closing valve 21. The second opening-and-closing valve 22 functions as a refrigerant circuit switching device which changes the refrigerant circuit by opening and closing the second refrigerant passage 14b.

Next, the indoor air-conditioning unit 30 is explained, which configures the air conditioner 1 with the refrigeration cycle apparatus 10. The indoor air-conditioning unit 30 blows off the air with temperature adjusted by the refrigeration cycle apparatus 10 to the vehicle interior. The indoor air-conditioning unit 30 is arranged at the inner side of the foremost instrument board (instrument panel) in the vehicle interior.

As shown in FIG. 1, the indoor air-conditioning unit 30 has the indoor condenser 12, the indoor evaporator 18, and the fan 32, which are housed in the casing 31 forming the outer shape. The casing 31 forms the air passage for the air to be sent to the vehicle interior. The casing 31 has a certain elasticity, and is fabricated by resin (for example, polypropylene) outstanding also in the strength.

The inside/outside air switch device 33 is arranged at the most upstream in the air flow in the casing 31. The inside/outside air switch device 33 switches inside air (indoor air of the vehicle) and outside air (outdoor air of the vehicle) to be introduced into the casing 31.

Specifically, the inside/outside air switch device 33 has an inside/outside air change door which adjusts continuously the opening areas of the inside air inlet port to introduce inside air into the casing 31 and the outside air inlet port to introduce outside air into the casing 31, to change continuously the ratio of the amount of inside air and the amount of outside air. The inside/outside air change door is driven by an electric actuator for the inside/outside air change door. The operation of the electric actuator is controlled by a control signal outputted from the air-conditioning control device 40.

The fan (blower) 32 is arranged downstream of the inside/outside air switch device 33 in the air flow. The fan 32 draws air through the inside/outside air switch device 33, and sends the air to the vehicle interior. The fan 32 is an electric blower in which a centrifugal multi-blade fan (sirocco fan) is driven by an electric motor. The number of rotations of the centrifugal multi-blade fan in the fan 32 is controlled by a control voltage outputted from the air-conditioning control device 40 to control the amount of air.

The indoor evaporator 18 and the indoor condenser 12 are arranged in this order at the downstream side of the fan 32 in the air flow. In other words, the indoor evaporator 18 is arranged upstream of the indoor condenser 12 in the air flow.

A cool-air bypass channel 35 is formed in the casing 31. The cool-air bypass channel 35 is a passage for making the air which passes through the indoor evaporator 18 to bypass the indoor condenser 12 and flow to the downstream side.

An air mixing door 34 is arranged downstream of the indoor evaporator 18 and upstream of the indoor condenser 12 in the air flow. The air mixing door 34 is used for adjusting the ratio of the amount of air passing through the indoor condenser 12 to the amount of air passing through the indoor evaporator 18. In the air conditioner 1, the amount of heat exchange in the indoor condenser 12 can be made the minimum by the air mixing door 34 which fully opens the cool-air bypass channel 35 and which fully closes the channel of air to the indoor condenser 12.

A mix space is defined downstream of the indoor condenser 12 in the air flow. In the mix space, the air heated by the indoor condenser 12 and the air which passes through the cool-air bypass channel 35 without heated by the indoor condenser 12 are mixed with each other. Plural opening holes are defined at the most downstream part of the casing 31 in the air flow. The air mixed in the mix space (conditioned wind) is blown off through the opening holes to the vehicle interior which is a target space for air-conditioning.

The opening holes may include a face opening hole, a foot opening hole, and a defroster opening hole (which are shown). The face opening hole is an opening hole for blowing off conditioned wind towards the upper half body of an occupant in the vehicle interior. The foot opening hole is an opening hole for blowing off conditioned wind towards a foot of the occupant. The defroster opening hole is an opening hole for blowing off conditioned wind towards an internal surface of a front windshield of the vehicle.

The face opening hole, the foot opening hole, and the defroster opening hole are respectively connected to the face blow-off port, the foot blow-off port, and the defroster blow-off port (neither is illustrated) defined in the vehicle interior through a duct which forms an air passage. The air mixing door 34 adjusts the ratio of the amount of air which passes the indoor condenser 12 and the amount of air which passes the cool-air bypass channel 35, to control the temperature of the conditioned air mixed in the mix space and blown off from each blow-off port to the vehicle interior.

The air mixing door 34 functions as a temperature adjustment part which adjusts the temperature of the conditioned wind to be sent to the vehicle interior. The air mixing door 34 is driven by an electric actuator for the air mixing door. The operation of the electric actuator is controlled by a control signal outputted from the air-conditioning control device 40.

A face door which adjusts the opening area of the face opening hole, a foot door which adjusts the opening area of the foot opening hole, and a defroster door which adjusts the opening area of the defroster opening hole (neither is illustrated) are arranged respectively upstream side of the face opening hole, the foot opening hole, and the defroster opening hole in the air flow.

The face door, the foot door, and the defroster door correspond to a blow-off port mode change door which changes the blow-off port mode. The face door, the foot door, and the defroster door are connected with an electric actuator for the blow-off port mode door through a linkage mechanism, respectively, to control the rotation. The operation of the electric actuator is controlled by a control signal outputted from the air-conditioning control device 40.

The blow-off port mode is changed by the blow-off port mode change door, among a face mode, a bilevel mode, and a foot mode.

The face mode is a blow-off port mode in which the face blow-off port is full open, to blow off air from the face blow-off port towards the upper half body of an occupant in the vehicle interior. The bilevel mode is a blow-off port mode in which both of the face blow-off port and the foot blow-off port are open, to blow off air towards the upper half body and the foot of an occupant in the vehicle interior. The foot mode is a blow-off port mode in which the foot blow-off port is full open, to blow off air from the foot blow-off port towards the foot of an occupant in the vehicle interior.

The defroster mode may be set by an occupant through a manual operation of the blow-off mode changeover switch prepared in the navigational panel 60. The defroster mode is a blow-off port mode in which the defroster blow-off port is fully open to blow off air from the defroster blow-off port to the internal surface of the front windshield.

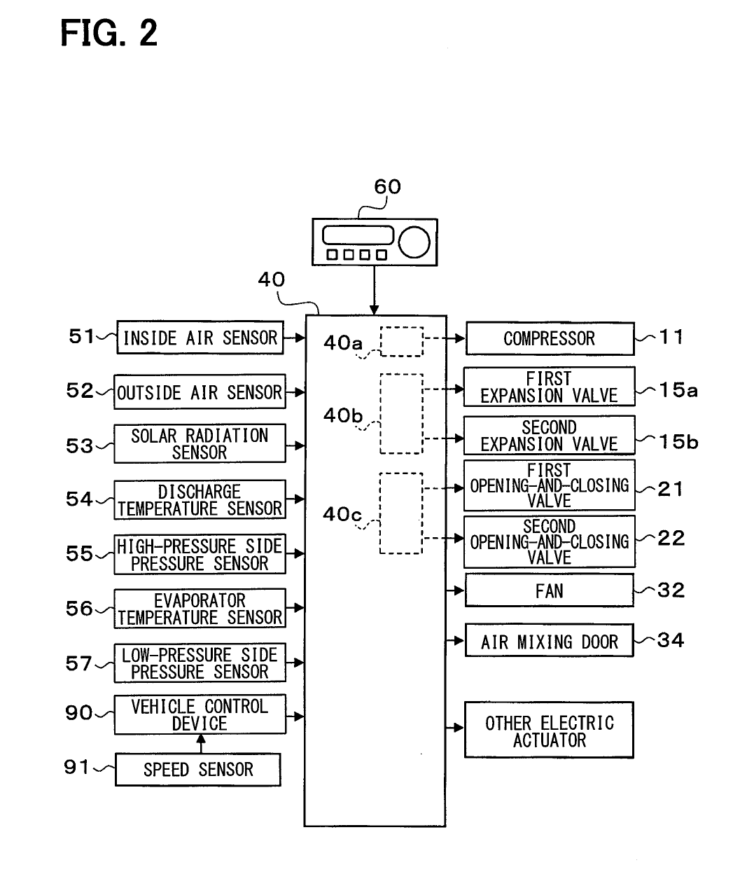

Next, the control system of the air conditioner 1 is explained, referring to FIG. 2. The air conditioner 1 has the air-conditioning control device 40 for controlling the refrigeration cycle apparatus 10 and the indoor air-conditioning unit 30.

The air-conditioning control device 40 includes a microcomputer with CPU, ROM, RAM and its circumference circuit. The air-conditioning control device 40 performs various calculating and processing based on the control program memorized in the ROM, to control the operation of the air-conditioning control device such as the compressor 11, the first expansion valve 15a, the second expansion valve 15b, the first opening-and-closing valve 21, the second opening-and-closing valve 22, the fan 32, and the air mixing door 34 connected to the output side.

The detection signals of the sensors for controlling the air-conditioning are inputted into the input side of the air-conditioning control device 40. As shown in FIG. 2, the inside air sensor 51, the outside air sensor 52, the solar radiation sensor 53, the discharge temperature sensor 54, the high-pressure side pressure sensor 55, the evaporator temperature sensor 56, and the low-pressure side pressure sensor 57 are provided for controlling the air-conditioning.

The inside air sensor 51 is an inside air temperature detecting element which detects the inside air temperature Tr in the vehicle interior. The outside air sensor 52 is an outside air temperature detecting element which detects the outside temperature Tam outside of the vehicle. The solar radiation sensor 53 is a solar radiation amount detecting element which detects the solar amount As irradiated to the vehicle interior. The discharge temperature sensor 54 is a discharge temperature detecting element which detects the temperature Td of refrigerant discharged from the compressor 11.

The high-pressure side pressure sensor 55 is a high-pressure side pressure sensing part which detects the pressure (the high-pressure side refrigerant pressure) Pc of refrigerant at the outlet side of the indoor condenser 12. The high-pressure side refrigerant pressure Pc is a pressure of refrigerant within the range from the discharge port side of the compressor 11 to the inlet side of the first expansion valve 15a in the heating mode. In the cooling mode, the high-pressure side refrigerant pressure Pc is a refrigerant pressure within the range from the discharge port side of the compressor 11 to the inlet side of the second expansion valve 15b. In the defrosting mode, the high-pressure side refrigerant pressure Pc is a refrigerant pressure within the range from the discharge port side of the compressor 11 to the inlet side of the first expansion valve 15a.

The condensing pressure of the refrigerant can be substituted by the condensing temperature. In the heating mode, the refrigerant temperature in the range from the discharge port of the compressor 11 to the inlet side of the first expansion valve 15a can be used to estimate the high pressure side refrigerant pressure Pc. In the cooling mode, the refrigerant temperature in the range from the discharge port of the compressor 11 to the inlet side of the second expansion valve 15b can be used to estimate the high pressure side refrigerant pressure Pc. In the defrosting mode, the refrigerant temperature in the range from the discharge port of the compressor 11 to the inlet side of the first expansion valve 15a can be used to estimate the high pressure side refrigerant pressure Pc.

The evaporator temperature sensor 56 is an evaporator temperature detecting element which detects the refrigerant evaporation temperature (evaporator temperature) Te in the indoor evaporator 18. The evaporator temperature sensor 56 detects the temperature of heat exchange fin of the indoor evaporator 18. A temperature detecting element which detects the temperature of the other part of the indoor evaporator 18 or a temperature detecting element which detects directly the temperature of the refrigerant itself which circulates the indoor evaporator 18 may be adopted as the evaporator temperature sensor 56.

The low-pressure side pressure sensor 57 is a low-pressure side pressure sensing part which detects the pressure of refrigerant on the low pressure side in the refrigeration cycle, and detects the refrigerant pressure at the inlet port side of the compressor 11 as the low-pressure side refrigerant pressure Ps. The low-pressure side refrigerant pressure Ps is a refrigerant pressure within the range from the outlet side of the first expansion valve 15a to the inlet port side of the compressor 11 in the heating mode. In the cooling mode, the low-pressure side refrigerant pressure Ps is a refrigerant pressure within the range from the outlet side of the second expansion valve 15b to the inlet port side of the compressor 11. In the defrosting mode, the low-pressure side refrigerant pressure Ps is a refrigerant pressure within the range from the outlet side of the first expansion valve 15a to the inlet port side of the compressor 11.

The evaporation pressure of the refrigerant can be substituted by the evaporation temperature. In the heating mode, the refrigerant temperature in the range from the outlet side of the first expansion valve 15a to the suction port of the compressor 11 can be used to estimate the low pressure side refrigerant pressure Ps. In the cooling mode, the refrigerant temperature in the range from the outlet side of the second expansion valve 15b to the suction port of the compressor 11 can be used to estimate the low pressure side refrigerant pressure Ps. In the defrosting mode, the refrigerant temperature in the range from the outlet side of the first expansion valve 15a to the suction side of the compressor 11 can be used to estimate the low pressure side refrigerant pressure Ps.

The navigational panel 60 is arranged near the instrument board at the front part of the vehicle interior, and is connected to the input side of the air-conditioning control device 40. The manipulation signal from various air-conditioning operation switches formed in the navigational panel 60 is inputted into the air-conditioning control device 40.

The various air-conditioning operation switches formed in the navigational panel 60 may include an auto switch, a cooling switch (A/C switch), an air amount setting switch, a temperature setting switch, and a blow-off mode changing switch.

The auto switch is an input unit for setting or canceling the automatic control operation of the air conditioner 1. The cooling switch is an input unit for requiring a cooling of the vehicle interior. The air amount setting switch is an input unit for manually setting the air amount sent by the fan 32. The temperature setting switch is an input unit for setting a vehicle interior preset temperature Tset which is a target temperature of the vehicle interior. The blow-off mode changing switch is an input unit for manually setting the blow-off mode.

A vehicle control device 90 is connected to the input side of the air-conditioning control device 40. The vehicle control device 90 conducts the various control about the driving of the vehicle including the air conditioner 1, and is connected with a vehicle speed sensor 91. The air conditioning control device 40 can acquire information representing the speed of the vehicle detected by the vehicle speed sensor 91 through the vehicle control device 90.

A control part (control device) which controls the various air-conditioning control apparatus is integrally connected to the output side of the air-conditioning control device 40. The configuration (hardware and software) which controls the operation of each air-conditioning control apparatus corresponds to the control part which controls the operation of each air-conditioning control apparatus.

For example, the air-conditioning control device 40 has a rotational speed controller 40a which controls the operation of the compressor 11. The air-conditioning control device 40 has a decompression controller 40b which controls the operation of the first expansion valve 15a and the second expansion valve 15b corresponding to a pressure reducing device. The air-conditioning control device 40 has a refrigerant circuit controller 40c which controls the operations of the first opening-and-closing valve 21 and the second opening-and-closing valve 22 corresponding to a refrigerant circuit switch device.

The rotational speed controller 40a, the decompression controller 40b and the refrigerant circuit controller 40c may be defined by other control part other than the air-conditioning control device 40.

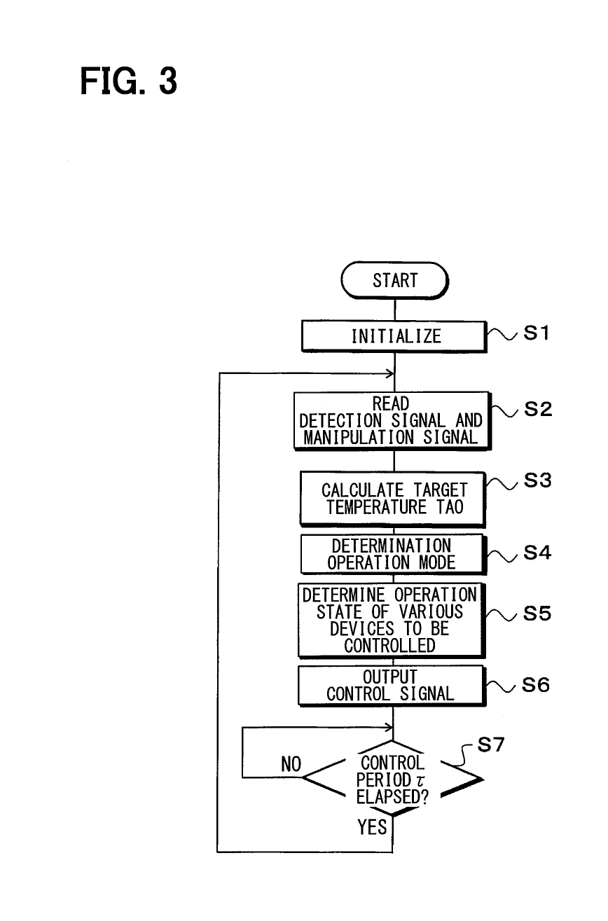

Next, the operation of the air conditioner 1 of the first embodiment is explained with reference to FIG. 3-FIG. 5. As mentioned above, in the air conditioner 1, the operation mode can be changed among the heating mode, the cooling mode, and the defrosting mode. The operation mode is changed by executing the air-conditioning control program memorized by ROM of the air-conditioning control device 40.

FIG. 3 is a flow chart describing the control processing as a main routine of the air-conditioning control program. The control processing of this main routine is performed when the auto switch of the navigational panel 60 is turned ON. Each control step in the flow chart shown in FIG. 3-FIG. 5 defines various kinds of functional parts of the air-conditioning control device 40.

As shown in FIG. 3, at S1, initialization is performed for the air conditioner 1. Specifically, the flag and the timer in the memory circuit of the air-conditioning control device 40 are initialized, and the positioning is initialized in the stepping motor of the electric actuators.

In the initialization of S1, some of the values such as flag or calculation value memorized when the vehicle system is ended or when the air conditioner is stopped last time may be read out.

Then, at S2, the detection signals of the sensors (such as the inside air sensor 51 to the low pressure side pressure sensor 57) for controlling the air-conditioning and the manipulation signal of the navigational panel 60 are read in. At this time, information regarding the travelling speed of the vehicle detected by the vehicle speed sensor 91 is read in through the vehicle control device 90.

At S3, the target blow-off temperature TAO which is the target temperature of the air blown off to the vehicle interior is calculated based on the detection signals and manipulate signals read at S2.

Specifically, the target blow-off temperature TAO is calculated by the expression F1 below.

TAO=Kset×Tset−Kr×Tr−Kam×Tam−Ks×As+C (F1)

Tset represents the vehicle interior preset temperature set by the temperature setting switch. Tr represents the vehicle interior (inside air) temperature detected by the inside air sensor 51. Tam represents the outside air temperature detected by the outside air sensor 52. As represents the amount of solar radiation detected by the solar radiation sensor 53. Kset, Kr, Kam, and Ks are control gains, and C is a constant for compensation.

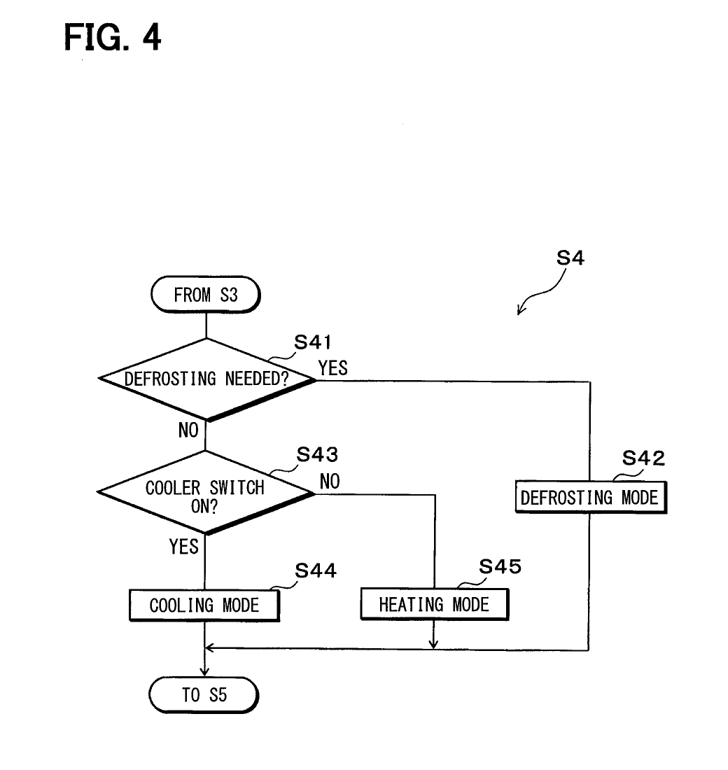

The operation mode is determined at S4. Specifically, at S4, the subroutine shown in FIG. 4 is performed by the air-conditioning control device 40.

First, at S41, it is determined whether the defrosting operation is needed for defrosting the outdoor heat exchanger 16.

In this determination, for example, when the outside temperature Tam is 0° C. or less and a value calculated by subtracting the temperature of the outdoor heat exchanger 16 from the outside temperature Tam is more than or equal to a predetermined temperature difference, it is determined that frost arises in the outdoor heat exchanger 16, and it is necessary to perform the defrosting operation. When it is determined that it is necessary to conduct the defrosting operation, the control part progresses to S42. When it is determined that it is not necessary to conduct the defrosting operation, the control part advances to S43.

In S42, the operation mode is set as the defrosting mode. Therefore, by executing S42, the air conditioning control device 40 functions as a defrosting controller. After the information indicating the determined operation mode is written in the RAM of the air-conditioning control device 40, the process proceeds to S5.

In S43, it is determined whether the cooling switch of the navigational panel 60 is turned on. When it is determined in S43 that the cooling switch is ON, the process proceeds to S44. In S44, the operation mode is set as the cooling mode. After the information indicating the determined operation mode is written in the RAM of the air-conditioning control device 40, the process proceeds to S5.

When it is determined in S43 that the cooling switch is OFF, the process proceeds to S45. In S45, the operation mode is set as the heating mode. After the information indicating the determined operation mode is written in the RAM of the air-conditioning control device 40, the process proceeds to S5.

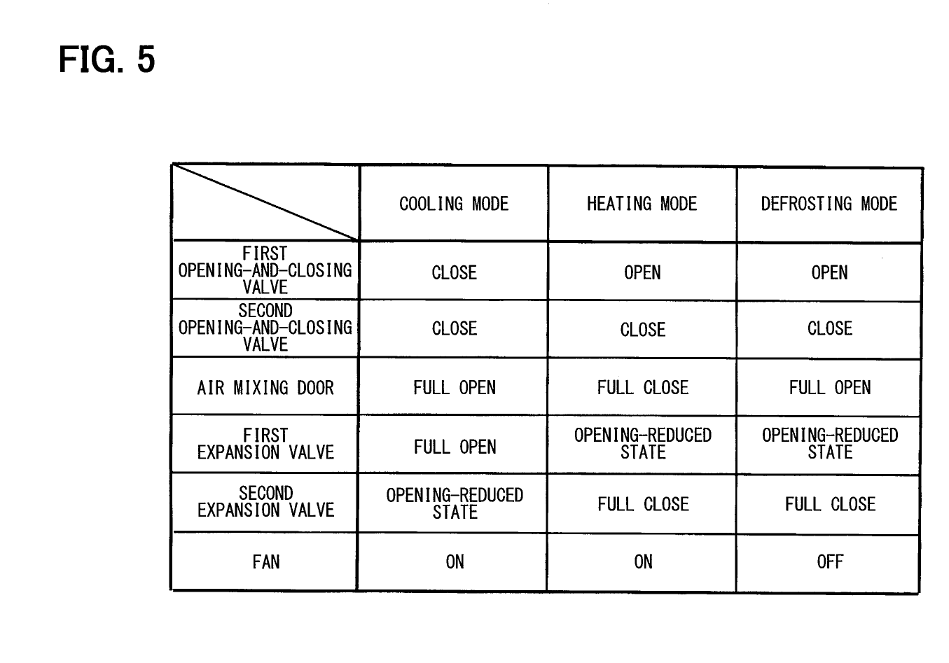

The process after S5 in the main routine of the air conditioning control program is described with reference to FIG. 3. In S5, the operational status of the various devices to be controlled is determined based on the operation mode determined at S4. More specifically, at S5, as shown in the chart of FIG. 5, the opening-and-closing state of the first opening-and-closing valve 21 and the second opening-and-closing valve 22, the position of the air mixing door 34, the opening degree of the first expansion valve 15a, the opening degree of the second expansion valve 15b, and the operation state of the fan 32 are determined.

Furthermore, the refrigerant discharge performance of the compressor 11 (namely, the rotational speed of the compressor 11), the operation state of the inside/outside air switch device 33, the operation state of the blow-off port mode change door (namely, blow-off port mode) are determined at S5, although they are not shown in FIG. 5.

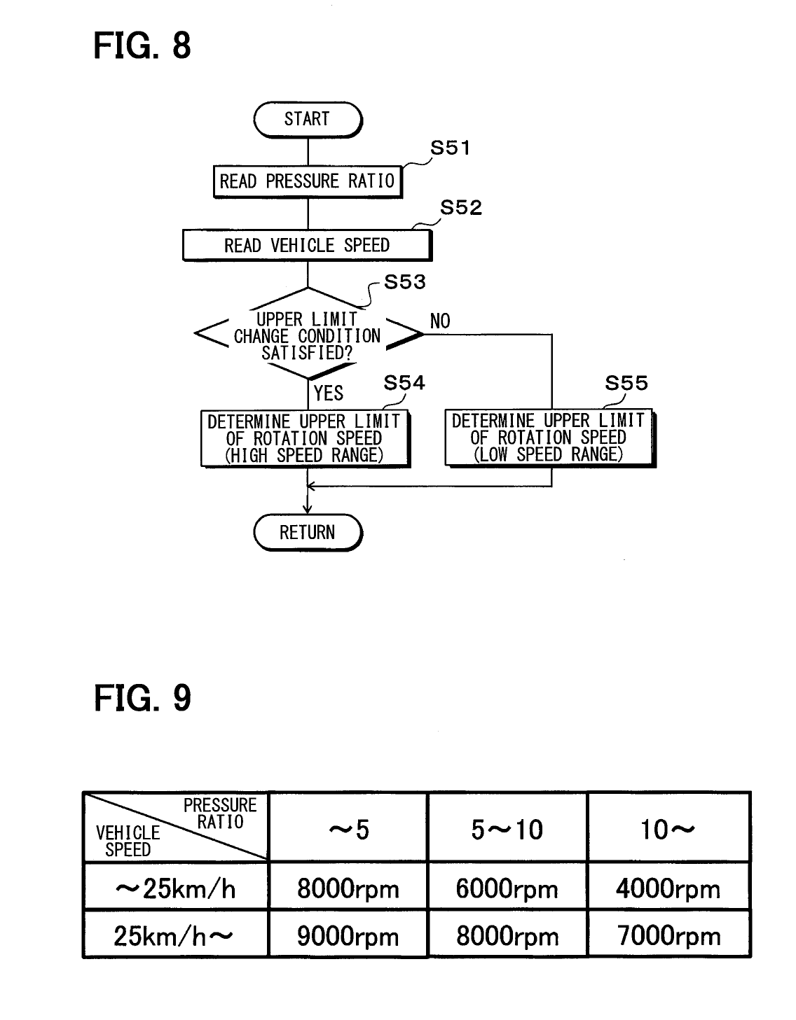

Prior to determining the rotational speed of the compressor 11 in S5, an upper limit value NcUL is determined to the rotational speed of the compressor 11. Specifically, the subroutine shown in FIG. 8 is executed by the air-conditioning control device 40, and will be described in detail later with reference to the drawings. In S5, the rotational speed Nc of the compressor 11 is determined so as not to exceed the upper limit value NcUL.

At S6, a control signal or control voltage is outputted from the air-conditioning control device 40 to various devices for controlling the air-conditioning so that the operation state determined at S5 can be acquired. At S7, when it is determined that a control period [symbol] , is elapsed, the control part returns to S2. In the air conditioner 1, the operation mode is determined like the above, and the operation is executed at each operation mode as follows.

### (a) Heating Mode

In the heating mode, as shown in the chart of FIG. 5, the air-conditioning control device 40 opens the first opening-and-closing valve 21, and closes the second opening-and-closing valve 22. Moreover, the first expansion valve 15a is made in the opening-reduced state to conduct a decompression action, and the second expansion valve 15b is made in the full closed state.

Thus, as shown in the black arrow of FIG. 1, in the heating mode, the vapor compression refrigeration cycle is defined to circulate refrigerant in order of the compressor 11, the indoor condenser 12, the first expansion valve 15a, the outdoor heat exchanger 16, (the first opening-and-closing valve 21), the accumulator 20, and the compressor 11.

Furthermore, with the configuration of this refrigerant circuit, as explained in S5, the air-conditioning control device 40 determines the operation state of the various air-conditioning devices at the heating mode, and outputs the control signals to the various air-conditioning devices.

For example, the control signal outputted to the electric motor of the compressor 11 is determined as follows. First, a target condensing pressure PCO in the indoor condenser 12 is determined with reference to the control map beforehand memorized by the air-conditioning control device 40 based on the target blow-off temperature TAO. On this control map, the target condensing pressure PCO is determined to increase as the target blow-off temperature TAO is raised.

The control signal to be outputted to the electric motor of the compressor is determined so that the high-pressure side refrigerant pressure Pc approaches the target condensing pressure PCO using the feedback control technique based on the deviation between the target condensing pressure PCO and the high-pressure side refrigerant pressure Pc detected by the high-pressure side pressure sensor 55. At this time, the control signal to be outputted to the compressor 11 is controlled by feedback control method such that the rotational speed Nc of the compressor 11 does not exceed the upper limit value NcUL determined in the subroutine shown in FIG. 5.

The control signal outputted to the electric actuator for driving the air mixing door causes the air mixing door 34 to fully close the cool-air bypass channel 35, such that the total flow of air passing the indoor evaporator 18 will pass through the air passage in the indoor condenser 12.

The control signal outputted to the first expansion valve 15a is determined such that the supercooling degree of refrigerant which flows into the first expansion valve 15a will approach a target supercooling degree. The target supercooling degree is a value determined such that the coefficient of performance (COP) of the cycle becomes the maximum.

The control voltage outputted to the electric motor of the fan 32 is determined with reference to the control map beforehand memorized by the air-conditioning control device 40 based on the target blow-off temperature TAO. In this control map, the amount of air is made the maximum when the target blow-off temperature TAO is in the very low temperature region (the maximum cooling region) and the very high temperature region (the maximum heating region).

As the target blow-off temperature TAO is increased toward a middle temperature region from the very low temperature region, the amount of air is decreased. As the target blow-off temperature TAO is decreased toward a middle temperature region from the very high temperature region, the amount of air is decreased. When the target blow-off temperature TAO is in the middle temperature region, the amount of air is made the minimum.

The control signal outputted to the electric actuator for the inside/outside air change door is determined with reference to the control map beforehand memorized by the air-conditioning control device 40 based on the target blow-off temperature TAO. On this control map, the outside air mode is set to introduce outside air fundamentally. When the target blow-off temperature TAO is in the high temperature region to get high heating performance, the inside air mode is set to introduce inside air.

The control signal outputted to the electric actuator for driving the blow-off port mode door is determined with reference to the control map beforehand memorized by the air-conditioning control device 40 based on the target blow-off temperature TAO. On this control map, as the target blow-off temperature TAO is lowered to a low temperature region from a high temperature region, the blow-off port mode is changed in order of the foot mode, the bilevel mode and the face mode.

Therefore, with the refrigeration cycle apparatus 10 at the heating mode, the high-pressure refrigerant breathed out from the compressor 11 flows into the indoor condenser 12. Since the air mixing door 34 opens the air passage in the indoor condenser 12, heat exchange is performed between the refrigerant which flowed into the indoor condenser 12 and the air sent from the fan 32 to pass the indoor evaporator 18, to radiate heat. Thereby, the air is heated.

Since the second opening-and-closing valve 22 is closed, the refrigerant which flowed out of the indoor condenser 12 flows into the first refrigerant passage 14a through the first three-way joint 13a, and is decompressed with the first expansion valve 15a to become a low-pressure refrigerant. The low-pressure refrigerant decompressed with the first expansion valve 15a flows into the outdoor heat exchanger 16, and absorbs heat from the outside air sent by the fan.

Since the first opening-and-closing valve 21 is opened and the second expansion valve 15b is in the full closed state, the refrigerant which flowed out of the outdoor heat exchanger 16 flows into the accumulator 20 through the second three-way joint 13b, the fourth refrigerant passage 14d, and the fourth three-way joint 13d, such that gas/liquid separation is carried out. The gas phase refrigerant separated with the accumulator 20 is drawn into the inlet side of the compressor 11, and is again compressed with the compressor 11.

Since the air heated with the indoor condenser 12 can be blown off to the vehicle interior in the heating mode, the vehicle interior can be heated.

### (b) Cooling Mode

In the cooling mode, as shown in the chart of FIG. 5, the air-conditioning control device 40 closes the first opening-and-closing valve 21 and the second opening-and-closing valve 22. Moreover, the air-conditioning control device 40 puts the first expansion valve 15a in the full open state, and puts the second expansion valve 15b in the opening-reduced state.

In the cooling mode, as shown in the white arrow of FIG. 1, the vapor compression refrigeration cycle is formed to circulate refrigerant in order of the compressor 11, the indoor condenser 12, (the first expansion valve 15a), the outdoor heat exchanger 16, (the check valve 17), the second expansion valve 15b, the indoor evaporator 18, the evaporating pressure regulating valve 19, the accumulator 20 and the compressor 11.

With the configuration of this refrigerant circuit, as explained in S5, the air-conditioning control device 40 determines the operation state of the various air-conditioning devices at the cooling mode.

For example, the control signal outputted to the electric motor of the compressor 11 is determined as follows. First, the target evaporation temperature TEO in the indoor evaporator 18 is determined with reference to the control map beforehand memorized by the air-conditioning control device 40 based on the target blow-off temperature TAO. On this control map, the target evaporation temperature TEO is reduced as the target blow-off temperature TAO is lowered. Furthermore, in order to restrict the frosting on the indoor evaporator 18, a lower limit (for example, 2° C.) is set for the target evaporation temperature TEO.

The control signal outputted to the electric motor of the compressor 11 is determined so that the refrigerant evaporation temperature Te approaches the target evaporation temperature TEO using the feedback control technique based on the deviation between the target evaporation temperature TEO and the refrigerant evaporation temperature Te detected by the evaporator temperature sensor 56. At this time, the control signal to be outputted to the compressor 11 is controlled by using a feedback control method so that the rotational speed Nc of the compressor 11 does not exceed the upper limit value NcUL determined by a subroutine to be described later.

The control signal outputted to the electric actuator of the air mixing door 34 causes the air mixing door 34 to fully open the cool-air bypass channel 35, and is determined such that the total flow of air passing the indoor evaporator 18 will pass through the cool-air bypass channel 35. In the cooling mode, the valve travel of the air mixing door 34 is controlled so that the air temperature TAV approaches the target blow-off temperature TAO.

The control signal outputted to the second expansion valve 15b is determined such that the supercooling degree of refrigerant which flows into the second expansion valve 15b will approach a target supercooling degree. The target supercooling degree is a value determined such that the coefficient of performance (COP) of the cycle becomes the maximum.

The control voltage outputted to the electric motor of the fan 32 is determined similarly as in the heating mode. The control signal outputted to the electric actuator for the inside/outside air change door is determined similarly as in the heating mode. The control signal outputted to the electric actuator for driving the blow-off port mode door is determined similarly as in the heating mode.

Therefore, with the refrigeration cycle apparatus 10 at the cooling mode, the high-pressure refrigerant discharged from the compressor 11 flows into the indoor condenser 12. At this time, since the air mixing door 34 fully closes the air passage in the indoor condenser 12, most of refrigerant which flowed into the indoor condenser 12 flows out of the indoor condenser 12, without carrying out heat exchange with air.

Since the second opening-and-closing valve 22 is closed, the refrigerant which flowed out of the indoor condenser 12 flows into the first refrigerant passage 14a through the first three-way joint 13a, and flows into the first expansion valve 15a. Since the first expansion valve 15a is in the full open state, the refrigerant which flowed out of the indoor condenser 12 flows into the outdoor heat exchanger 16, without being decompressed by the first expansion valve 15a.

The refrigerant which flowed into the outdoor heat exchanger 16 radiates heat in the outdoor heat exchanger 16 to the outside air sent by the fan. Since the first opening-and-closing valve 21 is closed, the refrigerant which flowed out of the outdoor heat exchanger 16 flows into the third refrigerant passage 14c through the second three-way joint 13b, and is decompressed by the second expansion valve 15b to be a low-pressure refrigerant.

The low-pressure refrigerant decompressed by the second expansion valve 15b flows into the indoor evaporator 18, and evaporates by absorbing heat from the air sent from the fan 32. Thereby, the air is cooled. The refrigerant which flowed out of the indoor evaporator 18 flows into the accumulator 20 through the evaporating pressure regulating valve 19, and gas/liquid separation is carried out. The gas phase refrigerant separated by the accumulator 20 is drawn into the inlet side of the compressor 11, and is again compressed by the compressor 11.

Thus, in the cooling mode, the vehicle interior can be cooled by blowing off the air cooled by the indoor evaporator 18 to the vehicle interior. Therefore, the air conditioner 1 of this embodiment can perform suitable air-conditioning for the vehicle interior by changing the operation mode between the heating mode and the cooling mode.

### (c) Defrosting Mode

In the defrosting mode, as shown in the chart of FIG. 5, the air-conditioning control device 40 opens the first opening-and-closing valve 21, and closes the second opening-and-closing valve 22. The first expansion valve 15a is made in the opening-reduced state to conduct a decompression, and the second expansion valve 15b is made in the full closed state.

In the defrosting mode, as shown in the horizontal hatching arrow in FIG. 1, a hot gas cycle is defined to circulate refrigerant in order of the compressor 11, the indoor condenser 12, the first expansion valve 15a, the outdoor heat exchanger 16, (the first opening-and-closing valve 21), the accumulator 20 and the compressor 11 as a vapor compression refrigeration cycle.

Furthermore, with the configuration of this refrigerant circuit, as explained in S5, the air-conditioning control device 40 determines the operation state of the various air-conditioning devices at the defrosting mode, and outputs the control signal to the various air-conditioning devices.

For example, the control signal outputted to the electric motor of the compressor 11 is determined to produce a predetermined rotational speed Nc, in order to achieve a predetermined refrigerant discharge performance.

The control signal outputted to the electric actuator for driving the air mixing door causes the air mixing door 34 to fully open the cool-air bypass channel 35, such that the total flow of air passing the indoor evaporator 18 will pass through the cool-air bypass channel 35. The control signal outputted to the electric motor of the fan 32 is determined to stop ventilation operation by the fan 32. Therefore, in the defrosting mode, heat is not exchanged with refrigerant in the indoor condenser 12.

The control signal outputted to the first expansion valve 15a is determined, in the defrosting mode, such that the open degree of the first expansion valve 15a becomes larger than that in the heating mode.

With the refrigeration cycle apparatus 10 at the defrosting mode, the high-pressure refrigerant discharged from the compressor 11 flows into the indoor condenser 12. At this time, since the air mixing door 34 fully closes the air passage in the indoor condenser 12, and operation of the fan 32 is also stopped, heat exchange is not carried out between the refrigerant which flowed into the indoor condenser 12 and air sent from the fan 32 to pass through the indoor evaporator 18.

Therefore, the refrigerant flows out of the indoor condenser 12 in the state of the hot gas with high temperature and high pressure. Since the second opening-and-closing valve 22 is closed, the refrigerant in the overheat state flows into the first refrigerant passage 14a through the first three-way joint 13a to reach the first expansion valve 15a. The refrigerant in the overheat state is decompressed to be low-pressure refrigerant after flowing into the first expansion valve 15a.

The low-pressure refrigerant decompressed by the first expansion valve 15a flows into the outdoor heat exchanger 16 on which frost is generated, while the refrigerant is still in the overheat state. Therefore, the frost on the outdoor heat exchanger 16 melts and is removed by the heat of the refrigerant in the overheat state.

Then, since the first opening-and-closing valve 21 is opened and the second expansion valve 15b is in the full closed state, the refrigerant which flowed out of the outdoor heat exchanger 16 flows into the fourth refrigerant passage 14d through the second three-way joint 13b, flows into the accumulator 20 through the fourth three-way joint 13d, and gas/liquid separation is carried out. The gas phase refrigerant separated by the accumulator 20 is drawn into the inlet side of the compressor 11, and is again compressed by the compressor 11.

As described above, in the defrosting mode, since the refrigerant in the overheated state can be circulated in the cycle including the outdoor heat exchanger 16, the frost can be removed from the outdoor heat exchanger 16.

As described above, in the air conditioner 1 according to the first embodiment, the refrigeration cycle apparatus 10 performs the cooling operation, the heating operation, and the defrosting operation by circulating the refrigerant by the compressor 11. Since the compressor 11 is operated in any of the operation modes in the refrigeration cycle apparatus 10, the operation noise of the compressor 11 is a main noise generated by the operation of the refrigeration cycle apparatus 10. An index indicating the operating state of the compressor 11 can be a rotational speed Nc indicating the refrigerant discharge capacity of the compressor 11.

In the refrigeration cycle apparatus 10, an indicator indicating differences in operating conditions such as the operation mode can be a high-pressure side refrigerant pressure Pc detected by the high pressure side pressure sensor 55 and a low-pressure side refrigerant pressure Ps detected by the low pressure side pressure sensor 57.

In order to consider both the high-pressure side refrigerant pressure Pc and the low-pressure side refrigerant pressure Ps, a pressure ratio is used as an index indicating the operating condition. The pressure ratio in the first embodiment is defined as a ratio of the high pressure side refrigerant pressure Pc to the low pressure side refrigerant pressure Ps and is expressed as Pc/Ps.

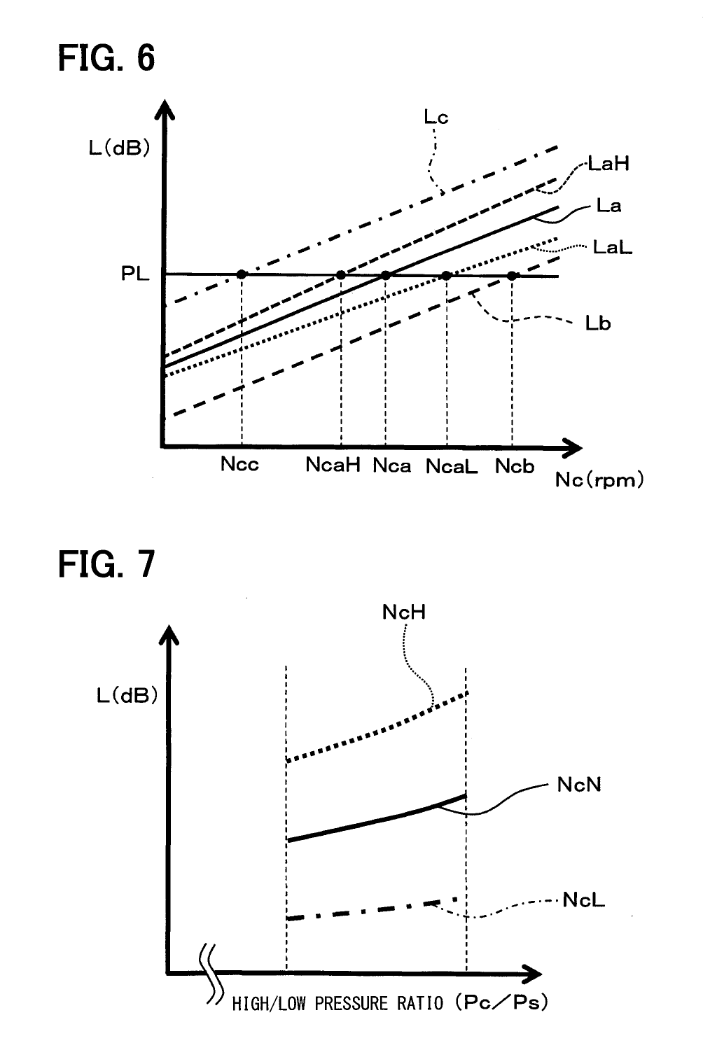

Then, the relationship between the noise level L associated with the operation of the refrigeration cycle apparatus 10 and the operation states of the compressor 11 and the refrigeration cycle apparatus 10 will be described with reference to FIGS. 6 and 7.

The graph in FIG. 6 shows the relationship between the noise level L during the operation of the refrigeration cycle apparatus 10 and the rotational speed Nc of the compressor 11 for each of plural operation situations in the refrigeration cycle apparatus 10. The noise level La in FIG. 6 indicates a noise level L in an operating situation with a certain high pressure side refrigerant pressure Pc and a certain pressure ratio (hereinafter referred to as standard pressure ratio).

The noise level Lb indicates a noise level L in an operating situation with a high-pressure side refrigerant pressure Pc lower than that of the noise level La and the standard pressure ratio. The noise level Lc indicates a noise level L in an operating situation with a high-pressure side refrigerant pressure Pc higher than that of the noise level La and the standard pressure ratio.

That is, the noise level La to the noise level Lc represent influences caused by the magnitude of the high-pressure side refrigerant pressure Pc on the noise level L among the situations where the high-pressure side refrigerant pressure Pc is different while the pressure ratio is fixed (that is, the standard pressure ratio).

Furthermore, in the graph shown in FIG. 6, the noise level LaH and the noise level LaL are described. The noise level LaH means a noise level L in an operating situation with a pressure ratio larger than the standard pressure ratio while the high pressure side refrigerant pressure Pc is the same as that of the noise level La. The noise level LaL means a noise level L in an operating situation with a pressure ratio smaller than the standard pressure ratio while the high pressure side refrigerant pressure Pc is the same as that of the noise level La.

That is, the noise level LaH, the noise level La, and the noise level LaL indicate influences caused by the magnitude of the pressure ratio on the noise level L among the situations where the pressure ratio is different while the high-pressure side refrigerant pressure Pc is fixed.

As shown in FIG. 6, the noise level L increases as the rotational speed Nc of the compressor 11 increases in each of the noise level La to the noise level Lc, the noise level LaH, and the noise level LaL.

A gradient of the increase in the noise level L with respect to the increase in the rotational speed Nc of the compressor 11 is substantially the same among the noise level La, the noise level Lb, and the noise level Lc. The noise level L is higher as the high-pressure side refrigerant pressure Pc is higher.

A gradient of the increase in the noise level L with respect to the increase in the rotational speed Nc of the compressor 11 is different among the noise level La, the noise level LaH, and the noise level LaL. Specifically, the gradient of the noise level LaH in which the pressure ratio is larger is larger than the gradient of the noise level La, and the gradient of the noise level LaL in which the pressure ratio is smaller is smaller than the gradient of the noise level La.

That is, when the high-pressure side refrigerant pressure Pc is the same, the magnitude of the pressure ratio corresponds to the magnitude of the influence caused by the rotational speed Nc of the compressor 11 on the noise level L. The noise level tends to converge to a certain noise level corresponding to the high-pressure side refrigerant pressure Pc as the rotational speed of the compressor 11 is smaller.

Based on these trends, an allowable noise level PL will be examined as the noise level L allowed for an occupant. As shown in FIG. 6, in the case of the noise level La, when the rotational speed Nc of the compressor 11 reaches a certain rotational speed Nca, the noise level reaches the allowable noise level PL.

In the case of the noise level Lb where the high pressure side refrigerant pressure Pc is lower than that of the noise level La, the noise level reaches the allowable noise level PL when the compressor has the rotational speed Ncb higher than the rotational speed Nca. In the case of the noise level Lc where the high pressure side refrigerant pressure Pc is higher than that of the noise level La, the noise level reaches the allowable noise level PL when the compressor has the rotational speed Ncc lower than the rotational speed Nca.

In the case of the noise level LaH having a pressure ratio higher than that of the noise level La, the noise level reaches the allowable noise level PL when the rotational speed Nc of the compressor 11 reaches the rotational speed NcaH lower than the rotational speed Nca. In the case of the low pressure ratio LaL having a pressure ratio lower than that of the noise level La, the noise level reaches the allowable noise level PL when the rotational speed Nc of the compressor 11 reaches the rotational speed NcaL higher than the rotational speed Nca.

Here, for example, the upper limit value NcUL of the rotational speed of the compressor 11 may be set only with the high-pressure side refrigerant pressure Pc, in order to suppress the noise level L below or equal to the allowable noise level PL. For example, if the high-pressure side refrigerant pressure Pc is a certain high-pressure side refrigerant pressure Pc in the case of the noise level La, the rotational speed Nca shown in FIG. 6 is set as the upper limit value NcUL.

In this case, if the pressure ratio is the same as that of the noise level La, the rotational speed Nc of the compressor 11 will not exceed the rotational speed Nca which is the upper limit value NcUL, so that the noise level L will not exceed the allowable noise level PL.

An operation may be made with a high pressure ratio where the high pressure side refrigerant pressure Pc is the same, in the state where the rotational speed Nca is set as the upper limit value NcUL. As shown in the noise level LaH in FIG. 6, if the rotational speed Nc of the compressor 11 is increased to the rotational speed Nca which is the upper limit value NcUL, the noise level La will exceed the allowable noise level PL. That is, even if the noise of the compressor 11 is suppressed using only the magnitude of the high-pressure side refrigerant pressure Pc, the noise level exceeds the allowable noise level PL, and the occupant recognizes the noise.

Next, consider a case where an operation is performed with a low pressure ratio while the high pressure side refrigerant pressure Pc is the same. As indicated by the noise level LaL in FIG. 6, the noise level in this case does not reach the allowable noise level PL at the time of the rotational speed Nca which is the upper limit value NcUL. The noise level reaches the allowable noise level PL at the time of the rotational speed NcaL which is higher than Nca. That is, the rotational speed Nc of the compressor 11 is restricted more than necessity, and it cannot be said that the rotational speed is adequately limited in consideration of the cycle efficiency, the air conditioning capability, and the like in the refrigeration cycle apparatus 10.

As described above, when the upper limit value NcUL of the rotational speed of the compressor 11 is set using only the high-pressure side refrigerant pressure Pc, the passenger may recognize the compression sound as noise, or the capacity of the compressor 11 may not be sufficiently used, so it cannot be said that an appropriate noise reduction effect has been obtained.

In this respect, as can be understood from the noise level La, the noise level LaH, and the noise level LaL in FIG. 6, the upper limit value NcUL can be set according to the situation by using the pressure ratio between the low-pressure side refrigerant pressure Ps and the high-pressure side refrigerant pressure Pc.

Although not shown in the drawing, a relationship between the noise level L and the rotational speed Nc of the compressor 11 among the operating conditions in which the pressure ratio is different with reference to the noise level Lb and a relationship between the noise level L and the rotational speed Nc of the compressor 11 among the operating conditions in which the pressure ratio is different with reference to the noise level Lc show the same tendency as the noise level La, the noise level LaH, and the noise level LaL in FIG. 6.

Next, the relationship between the pressure ratio and the noise level L will be described for each rotational speed Nc of the compressor 11 with reference to FIG. 7. The rotational speed NcN in FIG. 7 represents the relationship between the pressure ratio and the noise level L at a certain rotational speed Nc of the compressor 11.

The rotational speed NcH in FIG. 7 represents a relationship between the pressure ratio and the noise level L at a rotational speed Nc of the compressor 11, which is higher than the rotational speed NcN. The rotational speed NcL in FIG. 7 represents a relationship between the pressure ratio and the noise level at a rotational speed NcL of the compressor 11 which is lower than the rotational speed NcN.

As shown in the rotational speed NcL, the rotational speed NcN, and the rotational speed NcH in FIG. 7, the noise level L tends to increase as the pressure ratio increases, even at a constant rotational speed Nc. The influence caused by the increase in the pressure ratio on the increase in the noise level L is greater, as the rotational speed Nc of the compressor 11 is increased. Accordingly, the pressure ratio in the refrigeration cycle is closely related to the noise level L in the refrigeration cycle apparatus 10.

As described with reference to FIGS. 6 and 7, the pressure ratio between the high-pressure side refrigerant pressure Pc and the low-pressure side refrigerant pressure Ps has a strong correlation with respect to the noise level L in the refrigeration cycle apparatus 10. In the first embodiment, the upper limit value of the rotational speed Nc of the compressor 11 (that is, the upper limit value NcUL) is determined by using this pressure ratio, thereby realizing the noise reduction effect according to the driving situation.

As described above, in the refrigeration cycle apparatus 10 according to the first embodiment, upon determining the operation state of each of the various control target devices in S5, the air-conditioning control device 40 determines the rotational speed Nc of the compressor 11 as the control signal output to the compressor 11. That is, the upper limit value NcUL of the rotational speed of the compressor 11 is determined by executing the subroutine shown in FIG. 8, prior to determining the rotational speed Nc of the compressor 11 in S5.

As shown in FIG. 8, firstly in S51, the pressure ratio is read out. The pressure ratio is calculated by using the high pressure side refrigerant pressure Pc and the low pressure side refrigerant pressure Ps read in S2 and is obtained by dividing the high pressure side refrigerant pressure Pc by the low pressure side refrigerant pressure Ps. Thereafter, in S52, the vehicle speed detected by the vehicle speed sensor 91 is read out from the various detection signals read in S2.

In the following S53, it is determined whether an upper limit change condition is satisfied by using the vehicle speed and a control map shown in FIG. 9. As the upper limit change condition according to the first embodiment, it is determined whether the vehicle speed is in a high speed range, as a change in the situation of the vehicle on which the air conditioner 1 is mounted. S53 corresponds to a determination unit.

The control map according to the first embodiment will be described with reference to FIG. 9. As shown in FIG. 9, in this control map, the vehicle speed is classified into a low speed range where the vehicle speed is less than a certain reference speed (for example, 25 km/h) and a high speed range where the vehicle speed is equal to or higher than the reference speed. The upper limit value NcUL of the rotational speed of the compressor 11 is defined to correspond to a range of the pressure ratio in the refrigeration cycle apparatus 10, for each range of the vehicle speed.

As shown in FIG. 9, the upper limit value NcUL of the rotational speed of the compressor 11 is set to be smaller as the pressure ratio is larger, in each range of the vehicle speed. Further, when the range of pressure ratio is the same, the upper limit value NcUL of the rotational speed in the high speed range is set to be larger than the upper limit value NcUL of the rotation number in the low speed range.

When the speed range of the vehicle speed is different, the magnitude of noise caused by the travelling vehicle (for example, engine noise etc.) is also different. Noise caused by operation of the refrigeration cycle apparatus 10 (for example, operation noise of the compressor 11) is masked by the noise of the travelling vehicle. That is, the difference in the speed range of the vehicle speed is set to correspond to the magnitude of the masking effect due to the running sound of the vehicle.

Therefore, it is appropriate that the magnitude of the noise reduction effect by setting the upper limit value NcUL of the rotational speed of the compressor 11 changes in accordance with the speed range of the vehicle speed. As the speed range is lower, the greater noise reduction effect is required.

Accordingly, in S53, in order to realize the noise reduction effect according to the traveling state of the vehicle, the upper limit change condition is determined based on the vehicle speed. It is determined that the upper limit change condition is satisfied in the high speed range not less than a certain reference traveling speed (for example, 25 km/h). When the upper limit change condition is satisfied, the process proceeds to S54. When the upper limit change condition is not satisfied, the process proceeds to S55.

In S54, the upper limit value NcUL of the rotational speed of the compressor 11 is set using the pressure ratio read in S51, the speed range of the vehicle speed read out in S52, and the control map shown in FIG. 9. In this case, since the speed range of the vehicle speed is in the high speed range, one upper limit value NcUL corresponding to the pressure ratio is set among the plural upper limit values NcUL related to the high speed range. After that, this subroutine is terminated.

In S55, the upper limit value NcUL of the rotational speed of the compressor 11 is set using the pressure ratio read in S51, the speed range of the vehicle speed read out in S52, and the control map shown in FIG. 9. In this case, since the speed range of the vehicle speed is in the low speed range, one upper limit value NcUL corresponding to the pressure ratio is set among the plural upper limit values NcUL related to the low speed range. After that, this subroutine is terminated.

After the end of the subroutine shown in FIG. 8, in S5, a control signal indicating the rotational speed Nc of the compressor 11 is determined. At this time, when the rotational speed Nc of the compressor 11 specified from the target blown air temperature TAO or the like exceeds the upper limit value NcUL, the control signal is corrected to the upper limit value NcUL. As a result, during the subsequent air conditioning operation, the rotational speed Nc of the compressor 11 does not exceed the upper limit value NcUL, and the noise level L can be suppressed to be equal to or lower than the allowable noise level PL.

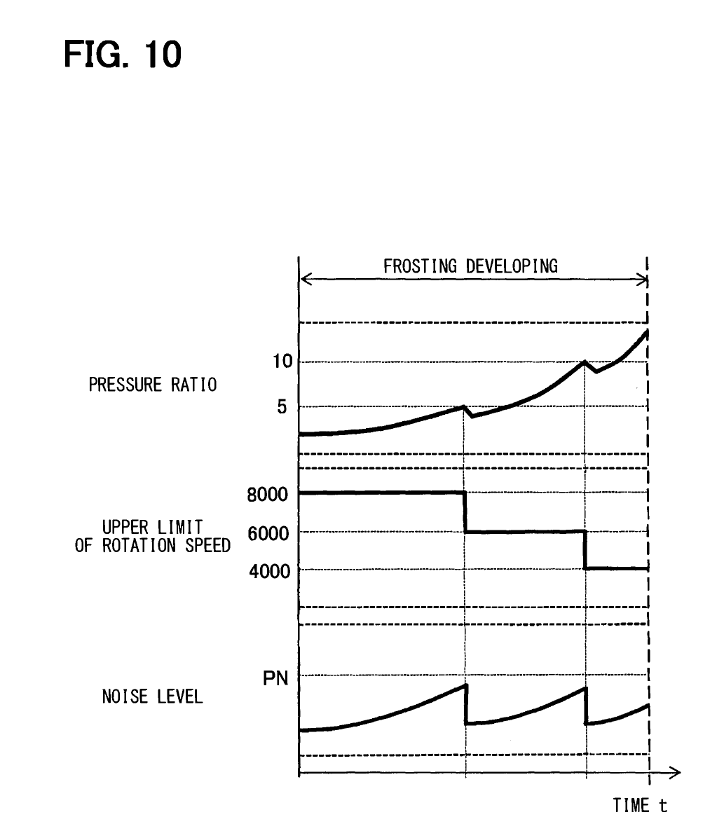

With respect to the refrigeration cycle apparatus 10 according to the first embodiment configured as described above, specific transition examples in the pressure ratio, the upper limit value NcUL of the rotational speed of the compressor 11, and the noise level L will be described in detail with reference to FIG. 10.

In the specific example shown in FIG. 10, the refrigeration cycle apparatus 10 of the air conditioner 1 is operating in the heating mode, and frost formed in the outdoor heat exchanger 16 is increasing. Further, it is assumed that the vehicle on which the air conditioner 1 is mounted stops or runs with a low speed range that is less than the reference speed.

In this specific example, the pressure ratio as the initial state is in the smallest range shown in FIG. 9. Therefore, the upper limit value NcUL of the rotational speed of the compressor 11 in this initial state is set to 8000 (rpm).

Under such circumstances, if the heating operation is continued while the vehicle stops or runs with the low speed range lower than the reference speed, the frost increases in the outdoor heat exchanger 16 in the refrigeration cycle apparatus 10. As the frost in the outdoor heat exchanger 16 increases, the heat absorption capacity of the outdoor heat exchanger 16 decreases, so that the pressure ratio increases in the refrigeration cycle apparatus 10. In conjunction with this, the rotational speed Nc of the compressor 11 increases, and the noise level L caused by the operation of the refrigeration cycle apparatus 10 gradually increases.

Then, as the frost of the outdoor heat exchanger 16 is further increased due to the continuation of the heating operation, the pressure ratio exceeds “5” defined in the control map of FIG. 9 and transitions to the next range. At this time, by executing the subroutine shown in FIG. 8, the upper limit value NcUL of the rotational speed of the compressor 11 is decreased to 6000 (rpm) before the noise level L exceeds the allowable noise level PL.

Since the upper limit value NcUL of the rotational speed of the compressor 11 is lowered, the operating noise of the compressor 11 decreases, so that the noise level L in the refrigeration cycle apparatus 10 is significantly reduced with the change in the upper limit value NcUL. At this time, since the refrigerant flow rate decreases by lowering the upper limit value NcUL, the pressure ratio in the refrigeration cycle apparatus 10 transiently decreases.

Even after the noise level L decreases, if the heating operation is continued while the vehicle stops or runs in the low speed range lower than the reference speed, the frost of the outdoor heat exchanger 16 is further increased. Also in this case, as the frost in the outdoor heat exchanger 16 increases, the pressure ratio in the refrigeration cycle apparatus 10 rises.

The rotational speed Nc of the compressor 11 increases as the heat absorption capacity of the outdoor heat exchanger 16 is decreased by the frosting. The noise level L that has been decreased by the change in the upper limit value NcUL is gradually raised again by a decrease in the heat absorption capacity of the outdoor heat exchanger 16.

As a result, due to the progress of frost in the outdoor heat exchanger 16, the pressure ratio exceeds “10” defined in the control map of FIG. 9 and is transitioned to the next range. At this time, by executing the subroutine shown in FIG. 8, the upper limit value NcUL of the rotational speed of the compressor 11 is reduced to 4000 (rpm) before the noise level L exceeds the allowable noise level PL.

As a result, since the operating noise of the compressor 11 decreases, the noise level L in the refrigeration cycle apparatus 10 is significantly reduced by the change in the upper limit value NcUL even when the frosting on the outdoor heat exchanger 16 further progresses. Also in this case, since the refrigerant flow rate is decreased by lowering the upper limit value NcUL, the pressure ratio in the refrigeration cycle apparatus 10 transiently decreases.

As described above, according to the refrigeration cycle apparatus 10 of the first embodiment, as the pressure ratio of the cycle increases, the upper limit value NcUL of the rotational speed of the compressor 11 is decreased. Therefore, the noise level L due to the operation of the refrigeration cycle apparatus 10 can be suppressed to be lower than the allowable noise level PL while corresponding to the situation.

In the specific example shown in FIG. 10, the case where the vehicle is stopped or running with the low speed range has been described, but as can be seen from the control map shown in FIG. 9, similar explanation can be made for a case where the vehicle is traveling in the high speed range. That is, the noise level L of the refrigeration cycle apparatus 10 can be suppressed to be lower than the allowable noise level PL even when the vehicle is traveling in the high speed range.

As shown in FIG. 9, the upper limit value NcUL of the rotational speed of the compressor 11 in the high speed range is set to be larger than the upper limit value in the low speed range. When traveling in a high speed range, the running sound of the vehicle increases, to increase the effect of masking the noise caused by the operation of the refrigeration cycle apparatus 10.

That is, according to the refrigeration cycle apparatus 10, by utilizing the masking effect due to the running noise of the vehicle, the performance of the compressor 11 can be raised in the high speed range more than in the low speed range. Simultaneously, even in this case, it is possible to obtain a noise reduction effect on the occupant by the masking effect due to the running noise of the vehicle.

As described above, according to the refrigeration cycle apparatus 10 of the first embodiment, it is possible to appropriately determine the operation state in the refrigeration cycle apparatus (for example, the frosting state of the outdoor heat exchanger 16) by using the pressure ratio calculated using not only the high-pressure side refrigerant pressure Pc in the cycle but also the low-pressure side refrigerant pressure Ps.

Further, in this refrigeration cycle apparatus 10, as shown in FIG. 9, the upper limit value NcUL of the rotational speed of the compressor 11 is lowered as the pressure ratio increases. Therefore, the noise caused by the operation of the refrigeration cycle apparatus 10 (mainly, the operation of the compressor 11) can be appropriately reduced in accordance with the operation state in the refrigeration cycle apparatus 10, and can be suppressed to be lower than the allowable noise level PL.

In the refrigeration cycle apparatus 10 according to the first embodiment, it is determined whether the vehicle on which the refrigeration cycle apparatus 10 is mounted is traveling in a high speed region equal to or higher than the reference traveling speed as the upper limit change condition in S53. The upper limit value NcUL is set according to the result of the determination. That is, the upper limit value NcUL of the rotational speed of the compressor 11 can be determined in consideration of not only the operation state of the refrigeration cycle apparatus 10 itself but also its surrounding environment (in this case, the running speed of the vehicle). Accordingly, more appropriate noise reduction effect can be exerted.

According to the refrigeration cycle apparatus 10 of the first embodiment, the upper limit value NcUL is set larger in the high speed range than in the low speed range, even though the pressure ratio is the same. When the vehicle is traveling in the high speed range, the masking effect due to the running noise increases. Therefore, even if the rotational speed of the compressor 11 is raised, the same noise reduction effect is expected by utilizing the masking effect.

According to the refrigeration cycle apparatus 10, the performance of the compressor 11 is fully demonstrated by setting the upper limit value NcUL larger in the high speed range. At the same time, sufficient noise reduction effect can be realized by using the masking effect. Accordingly, while utilizing the compressor 11 according to the situation, the noise reduction effect is compatible.

### Second Embodiment

A second embodiment will be described with reference to the drawings. The air conditioner 1 according to the second embodiment is basically the same as the first embodiment except for the control map and the subroutine executed prior to the determination of the control signal for the compressor 11 in S5. In the following description, the same reference numerals as those in the first embodiment indicate the same configuration, and the reference is made to the preceding description.

In the second embodiment, the control map and the subroutine executed when determining the upper limit value NcUL of the rotational speed of the compressor 11 in S5 are different from those of the first embodiment. Hereinafter, the points in the air conditioner 1 according to the second embodiment different from the first embodiment will be described with reference to the drawings.

Similarly to the first embodiment, the air conditioner 1 is defined by the indoor air-conditioning unit 30, the air-conditioning control device 40, and the refrigeration cycle apparatus 10, which is mounted on a vehicle, according to the second embodiment. The refrigeration cycle apparatus 10 is capable of switching the refrigerant circuit among the heating mode, the cooling mode, and the defrosting mode.

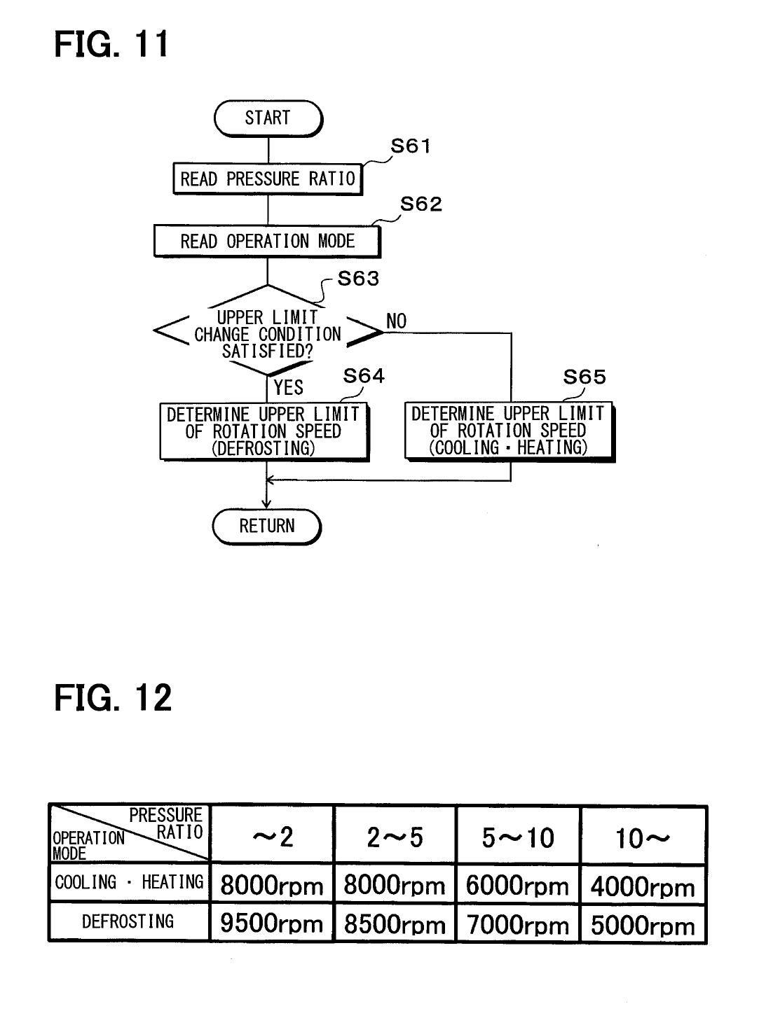

As shown in FIG. 11, in S61, the pressure ratio is read out as in S51 in the first embodiment. In the following S62, the operation mode determined in S4 is confirmed. Then, in S63, it is determined whether the upper limit change condition is satisfied based on the confirmed operation mode. Step S63 is equivalent to a determination unit.

As the upper limit change condition in the second embodiment, it is determined whether or not the operation mode is the defrosting mode. Hereinafter, the reason why the upper limit change condition in the second embodiment is set to whether or not the operation mode is the defrost mode will be described.

In the refrigeration cycle apparatus 10, the outdoor heat exchanger 16 functions as a heat absorber in the heating mode, and the temperature becomes lower than or equal to the ambient temperature (for example, the outside air temperature Tam). In the cooling mode, the indoor evaporator 18 functions as a heat absorber, and the temperature becomes lower than or equal to the ambient temperature (that is, the temperature of the blown air in the indoor air-conditioning unit 30).

In the defrosting mode, the defrosting operation is executed for the outdoor heat exchanger 16 which forms the refrigerant circuit, in order to remove the frost from the outdoor heat exchanger 16, such that the temperature becomes higher than or equal to the ambient temperature (for example, outside air temperature Tam).

As a result, the correlation between the high pressure side refrigerant pressure Pc and the low pressure side refrigerant pressure Ps in the refrigeration cycle is similar between the heating mode and the cooling mode, but the correlation in the defrosting mode is different from that in the heating mode and the cooling mode.

The upper limit change condition according to the second embodiment is set in order to reflect the difference in the correlation between the high pressure side refrigerant pressure Pc and the low pressure side refrigerant pressure Ps according to the operation mode, so as to set the upper limit value NcUL of the rotational speed of the compressor 11.

When the operation mode is the defrosting mode, it is determined that the upper limit change condition is satisfied, and the process proceeds to S64. In S64, the upper limit value NcUL of the rotational speed of the compressor 11 in the defrosting mode is set using the pressure ratio read out in S61 and the control map shown in FIG. 12.

Here, the control map in the second embodiment will be described with reference to FIG. 12. As shown in FIG. 12, this control map is defined for the case of the cooling mode and the heating mode, and the case of the defrosting mode. The upper limit value NcUL of the rotational speed of the compressor 11 is set to correspond to a range of the pressure ratio in the refrigeration cycle apparatus 10, for each operation mode.

As shown in FIG. 12, the upper limit value NcUL of the rotational speed of the compressor 11 decreases as the pressure ratio is increased, in each operation mode. Further, the upper limit value NcUL of the rotational speed is higher in the defrosting mode than in the cooling mode and the heating mode, even when the pressure ratio is the same.

Therefore, in S64, the upper limit value NcUL of the rotational speed of the compressor 11 is appropriately set according to the operation state (that is, the pressure ratio) of the refrigeration cycle apparatus 10 in the defrosting mode. After that, this subroutine is terminated.

When the operation mode is not the defrosting mode (that is, in the cooling mode or the heating mode), it is determined that the upper limit change condition is not satisfied, and the process proceeds to S65. In S65, the upper limit value NcUL of the rotational speed of the compressor 11 is set using the pressure ratio read in S61 and the control map shown in FIG. 12, in the cooling mode and in the heating mode.

In this case, in S65, the upper limit value NcUL of the rotational speed of the compressor 11 is appropriately set according to the operation state (that is, the pressure ratio) of the refrigeration cycle apparatus 10 in the cooling mode and the heating mode. After that, this subroutine is terminated.

After the end of the subroutine shown in FIG. 11, similarly to the first embodiment, in S5, a control signal indicating the rotational speed Nc of the compressor 11 is determined. At this time, when the rotational speed Nc of the compressor 11 specified from the target blown air temperature TAO or the like exceeds the upper limit value NcUL, the control signal is corrected to indicate the upper limit value NcUL. As a result, also in the second embodiment, the rotational speed Nc of the compressor 11 does not exceed the upper limit value NcUL in the subsequent air conditioning operation, and the noise level L can be suppressed below the allowable noise level PL.

As described above, according to the refrigeration cycle apparatus 10 of the second embodiment, it is possible to appropriately determine the driving situation in the refrigeration cycle apparatus by using the pressure ratio calculated using not only the high-pressure side refrigerant pressure Pc in the cycle but also the low-pressure side refrigerant pressure Ps. Further, in this refrigeration cycle apparatus 10, as shown in FIG. 12, the upper limit value NcUL of the rotational speed of the compressor 11 is lowered as the pressure ratio increases. Therefore, the noise caused by the operation of the refrigeration cycle apparatus 10 (mainly, the operation of the compressor 11) can be appropriately reduced in accordance with the operation state in the refrigeration cycle apparatus 10, and can be suppressed lower than the allowable noise level PL.

Further, in the refrigeration cycle apparatus 10 according to the second embodiment, it is determined whether the operation mode of the refrigeration cycle apparatus 10 is the defrosting mode as the upper limit change condition in S63, and the upper limit value NcUL is set in accordance with the result of the determination. In other words, the refrigeration cycle apparatus 10 can determine the upper limit value NcUL of the rotational speed of the compressor 11 in consideration of the operation mode and the operation state of the refrigeration cycle apparatus 10, so that it is possible to achieve more appropriate noise reduction effect.

According to the refrigeration cycle apparatus 10 of the second embodiment, even when the range of the pressure ratio is the same, the upper limit value NcUL of the rotational speed is set larger in the defrosting mode than in the cooling mode and the heating mode. Accordingly, the refrigeration cycle apparatus 10 can realize an appropriate noise reduction effect in accordance with the difference in correlation between the high-pressure-side refrigerant pressure Pc and the low-pressure-side refrigerant pressure Ps depending on the operation mode.

According to the refrigeration cycle apparatus 10, the difference in the operation mode can be reflected on the upper limit value NcUL. Therefore, it is possible to sufficiently exert the performance of the compressor 11 and at the same time to obtain a sufficient noise reduction effect. Accordingly, it is possible to realize compatibility between utilization of the compressor 11 and noise reduction effect depending on the situation.

### Other Embodiments

Although the embodiments have been described above, the present disclosure is not limited to the above-described embodiments, and various improvements and modifications can be made without departing from the spirit of the present disclosure. For example, each of the above-described embodiments may be arbitrarily combined, or various modifications of the above-described embodiments are possible.

(1) In the refrigeration cycle apparatus 10 according to the above-described embodiment, the upper limit value NcUL of the rotational speed of the compressor 11 is changed in accordance with the increase in the pressure ratio, but is not limited to this mode. That is, it is also possible to change the upper limit value NcUL and the lower limit value of the rotational speed of the compressor 11 as the pressure ratio increases. With this configuration, since the potential range of the rotational speed Nc of the compressor 11 can be limited, it is possible to ensure air conditioning performance in the refrigeration cycle apparatus 10 while exerting noise reduction effect according to the operation state of the refrigeration cycle apparatus 10.

(2) In the above-described embodiment, the upper limit value NcUL of the rotational speed of the compressor 11 is determined based on the pressure ratio obtained by dividing the high-pressure side refrigerant pressure Pc by the low-pressure side refrigerant pressure Ps, however, is not limited to. For example, it is possible to determine the upper limit value NcUL based on a pressure difference between the high-pressure side refrigerant pressure Pc and the low-pressure side refrigerant pressure Ps.

(3) In the above-described embodiment, the control map referred to when determining the upper limit value NcUL is merely an example, and the control map is not limited to the example shown in FIG. 9 and FIG. 12. For example, the pressure ratio may be divided into further small ranges in each control map. Likewise, the vehicle speed in FIG. 9 and the driving mode in FIG. 12 can also be further subdivided into small ranges. If the control map is defined by the further subdividing, it is possible to respond to, more accurately, changes in various situations.

(4) In the above-described embodiment, the refrigeration cycle apparatus 10 is capable of switching the circuit between the cooling operation, the heating operation, and the defrosting operation, but is not limited to this mode. For example, as an operation mode, a dehumidifying heating operation may be performed by heating a dehumidified air to send the dehumidified and heated air into the passenger compartment. The dehumidifying heating operation may be performed by the outdoor heat exchanger and the indoor evaporator connected in series or parallel to the refrigerant flow, or by switching a refrigeration cycle between the series connection and the parallel connection according to the situation.

(5) It is determined whether the vehicle on which the refrigeration cycle apparatus is mounted is running at a predetermined reference speed or more as the upper limit change condition. It is not determined that the vehicle is running at the reference speed or more, when the vehicle is stopped, in addition to the case where the vehicle is traveling at a speed lower than the reference speed.

(6) The defrosting operation of the evaporator is performed to remove the frost from the evaporator by flowing the refrigerant from the electric compressor to the evaporator. However, it is not limited that the refrigerant discharged from the discharge port of the electric compressor flows into the evaporator to defrost the evaporator. That is, as the defrosting operation, defrosting with hot gas may be performed as in the above-described embodiment, or a so-called reverse cycle defrosting may be performed by temporarily performing a cooling operation to remove frost which is formed during a heating operation.

What is claimed is:

1. A refrigeration cycle apparatus for an air conditioner comprising:
an electric compressor that compresses and discharges refrigerant;
a heating heat exchanger that heats a fluid by high pressure refrigerant discharged from the electric compressor as a heat source;
a decompressor that decompresses the refrigerant flowing from the heating heat exchanger;
an evaporator that evaporates the refrigerant decompressed by the decompressor; and
a rotational speed controller that controls a rotational speed of the electric compressor, wherein
the rotational speed controller is configured to reduce an upper limit value of the rotational speed of the electric compressor in accordance with an increase in a pressure ratio of a high-pressure side refrigerant pressure of refrigerant within a range from a discharge port of the compressor to an inlet side of the decompressor to a low-pressure side refrigerant pressure of refrigerant within a range from an outlet side of the decompressor to a suction port of the compressor.

2. The refrigeration cycle apparatus according to claim 1, further comprising:
a determination unit that determines whether a predetermined upper limit change condition is satisfied, wherein
when it is determined that the upper limit change condition is satisfied, the rotational speed controller increases the upper limit value of the rotational speed of the electric compressor to be larger than that in case where the upper limit change condition is not satisfied.

3. The refrigeration cycle apparatus according to claim 2, wherein
the determination unit determines whether a vehicle on which the refrigeration cycle apparatus is mounted is traveling at or above a predetermined reference speed as the upper limit change condition, and
when it is determined that the vehicle is traveling at or above the reference speed, the rotational speed controller increases the upper limit value of the rotational speed of the electric compressor to be larger than that in case where it is not determined that the vehicle is traveling at or above the reference speed.

4. The refrigeration cycle apparatus according to claim 2, further comprising:
a defrosting controller that causes a refrigerant discharged from the electric compressor to flow into the evaporator to perform a defrosting operation of the evaporator, wherein
the determination unit determines whether the defrosting operation of the evaporator is performed by the defrosting controller as the upper limit change condition, and
when it is determined that the defrosting operation of the evaporator is performed by the defrosting controller, the rotational speed controller increases the upper limit value of the rotational speed of the electric compressor to be larger than that in case where it is not determined that the defrosting operation of the evaporator is performed by the defrosting controller.

5. A refrigeration cycle apparatus for an air conditioner comprising:
an electric compressor that compresses and discharges refrigerant;
a heating heat exchanger that heats a fluid by high pressure refrigerant discharged from the electric compressor as a heat source;
a decompressor that decompresses the refrigerant flowing from the heating heat exchanger;
an evaporator that evaporates the refrigerant decompressed by the decompressor; and
a controller including
a memory and
a processor coupled to the memory and configured to reduce an upper limit value of a rotational speed of the electric compressor in response to an increase in a pressure ratio of a high-pressure side refrigerant pressure of refrigerant within a range from a discharge port of the compressor to an inlet side of the decompressor to a low-pressure side refrigerant pressure of refrigerant within a range from an outlet side of the decompressor to a suction port of the compressor.

6. The refrigeration cycle apparatus according to claim 5, wherein
the processor determines whether a predetermined upper limit change condition is satisfied,
when it is determined that the upper limit change condition is satisfied, the processor increases the upper limit value of the rotational speed of the electric compressor to be larger than that in case where the upper limit change condition is not satisfied.

7. The refrigeration cycle apparatus according to claim 6, wherein
the processor determines whether a vehicle on which the refrigeration cycle apparatus is mounted is traveling at or above a predetermined reference speed as the upper limit change condition, and
when it is determined that the vehicle is traveling at or above the reference speed, the processor increases the upper limit value of the rotational speed of the electric compressor to be larger than that in case where it is not determined that the vehicle is traveling at or above the reference speed.

8. The refrigeration cycle apparatus according to claim 6, wherein
the processor causes a refrigerant discharged from the electric compressor to flow into the evaporator to perform a defrosting operation of the evaporator,
the processor determines whether the defrosting operation of the evaporator is performed as the upper limit change condition, and
when it is determined that the defrosting operation of the evaporator is performed, the processor increases the upper limit value of the rotational speed of the electric compressor to be larger than that in case where it is not determined that the defrosting operation of the evaporator is performed.
